(19) United States
(12) Patent Application Publication
(10) Pub. No.: US 2024/0194924 A1
(43) Pub. Date: Jun. 13, 2024

(54) FUEL CELL STACK

(71) Applicant: TOYOTA JIDOSHA KABUSHIKI KAISHA, Toyota-shi (JP)

(72) Inventors: Chihiro OMORI, Susono-shi (JP); Hideaki TANAKA, Fuji-shi (JP)

(21) Appl. No.: 18/529,150

(22) Filed: Dec. 5, 2023

(30) Foreign Application Priority Data
Dec. 12, 2022 (JP) 2022-197605

(51) Int. Cl. H01M 8/247; H01M 8/0432; H01M 8/04664

(52) U.S. Cl. CPC H01M 8/247; H01M 8/04365; H01M 8/04679

(57) ABSTRACT

To provide a fuel cell stack having a high degree of freedom in design. A fuel cell stack, wherein the fuel cell stack is a stack of a plurality of single cells; wherein the fuel cell stack comprises a fastening member and a predetermined sensor; wherein the fastening member is rod-shaped; wherein the fastening member is arranged along a stacking direction of the single cells; wherein the predetermined sensor is attached to the fastening member; and wherein the predetermined sensor is configured to monitor a condition of the single cells in a state of being attached to the fastening member.

### TECHNICAL FIELD

The present disclosure relates to a fuel cell stack.

### BACKGROUND

Various studies have been made on fuel-cells (FC) as disclosed in Patent Literatures 1 and 2.
Patent Literature 1: Japanese Patent Application Laid-Open (JP-A) No. 2010-287385
Patent Literature 2: JP-A No. 2022-109703

In the prior art, the degree of freedom in designing the fuel cell stack is low.

### SUMMARY

The present disclosure was achieved in light of the above circumstances. An object of the present disclosure is to provide a fuel cell stack having a high degree of freedom in design.

The fuel cell stack of the present disclosure is a fuel cell stack,
wherein the fuel cell stack is a stack of a plurality of single cells;
wherein the fuel cell stack comprises a fastening member and a predetermined sensor;
wherein the fastening member is rod-shaped;
wherein the fastening member is arranged along a stacking direction of the single cells;
wherein the predetermined sensor is attached to the fastening member; and
wherein the predetermined sensor is configured to monitor a condition of the single cells in a state of being attached to the fastening member.

In the fuel cell stack of the present disclosure, the predetermined sensor may be at least one of a cell monitor and a temperature sensor.

The present disclosure can provide the fuel cell stack having a high degree of freedom in design.

### BRIEF DESCRIPTION OF THE DRAWINGS

In the accompanying drawings,

FIG. 1 shows a schematic plan view showing an example of the fuel cell stack of the present disclosure;

FIG. 2 shows a schematic side view showing an example of the fuel cell stack of the present disclosure;

FIG. 3 shows a schematic side view illustrating an example of the predetermined sensor attached to the fastening member of the present disclosure; and

FIG. 4 shows a schematic side view showing another example of the predetermined sensor attached to the fastening member of the present disclosure.

### DETAILED DESCRIPTION

Hereinafter, the embodiments of the present disclosure will be described in detail. Matters that are required to implement the present disclosure (such as common fuel cell stack structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

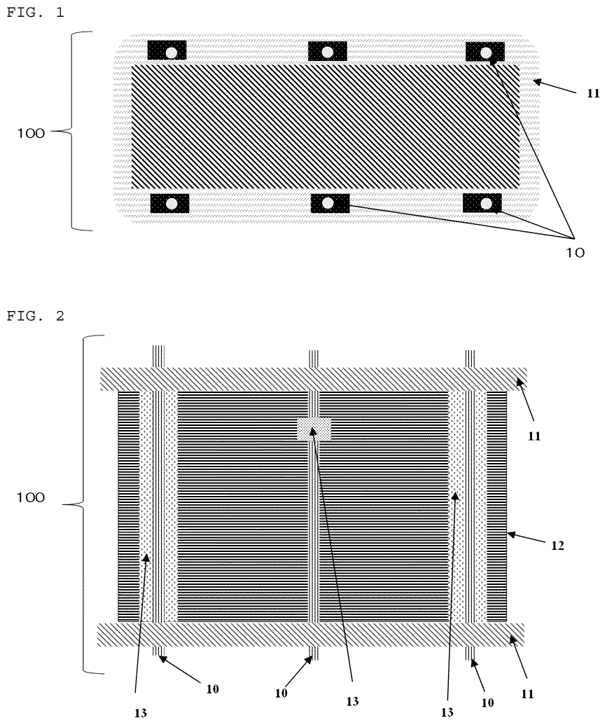

In FIGS. 1 to 4, parameters relating to size (such as length, width and thickness) are not parameters reflecting the actual size.

In the Specification, “-” used to indicate a numerical range, is used to mean that the range includes the numerical values described before and after “-” as the lower and the upper limit values.

Also in the Specification, the upper and lower limit values of the numerical range may be a desired combination.

The fuel cell stack of the present disclosure is a fuel cell stack,
wherein the fuel cell stack is a stack of a plurality of single cells;
wherein the fuel cell stack comprises a fastening member and a predetermined sensor;
wherein the fastening member is rod-shaped;
wherein the fastening member is arranged along a stacking direction of the single cells;
wherein the predetermined sensor is attached to the fastening member; and
wherein the predetermined sensor is configured to monitor a condition of the single cells in a state of being attached to the fastening member.

Patent Literatures 1-2 describe how to secure the cell monitor to a single cell.

In Patent Literature 1, since the cell monitors are fixed to the single cells at once by fixing the connectors of the cell monitors to one fixed base, it is necessary to fix the single cells at once, and if one single cell is displaced, all the single cells are displaced, so that it is necessary to securely connect all the single cells at once. Therefore, it is difficult to connect individual cell monitors to each single cell.

In Patent Literature 2, a fixation process is required for both the single cell and the cell monitor, and the position of the connecting portion between the single cell and the cell monitor is determined.

Thus, the techniques described in Patent Literatures 1-2 are less flexible in designing the fuel cell stack.

In the present disclosure, a predetermined sensor is fixed to a fastening member required for stacking unit cells of a fuel cell. This eliminates the need for processing to fix a predetermined sensor to a single cell, and improves the degree of freedom in designing the fuel cell stack.

FIG. 1 shows a schematic plan view showing an example of the fuel cell stack of the present disclosure.

Six fastening members 10 and an end plate 11 are disposed in the fuel cell stack 100. The number of the fastening members 10 is not limited to six. The number of the fastening members 10 may be any number that can apply a fastening load to the fuel cell stack 100.

FIG. 2 shows a schematic side view showing an example of the fuel cell stack of the present disclosure.

The fuel cell stack 100 of the present disclosure includes an end plate 11, a stack of single cells 12, and an end plate 11 stacked in this order. The fastening member 10 is disposed in the fuel cell stack 100 along the stacking direction of the unit cells 12. The fastening member 10 is inserted into the through holes of the two end plates 11. A fastening load is applied in the stacking direction of the single cells 12 by screw fastening of the upper and lower two nuts of the fastening member 10.

A predetermined sensor 13 is attached to the fastening member 10. The predetermined sensor 13 can be fixed to any position of the fastening member 10, and the degree of freedom in design of the fuel cell stack 100 is improved.

FIG. 3 shows a schematic side view illustrating an example of the predetermined sensor attached to the fastening member of the present disclosure.

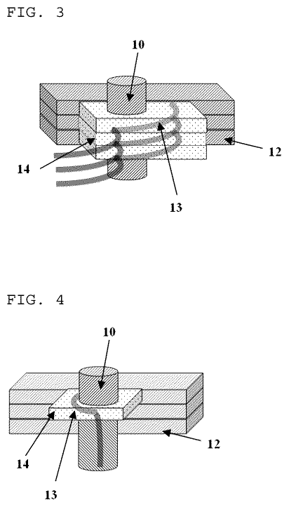

FIG. 4 shows a schematic side view showing another example of the predetermined sensor attached to the fastening member of the present disclosure.

As shown in FIGS. 3 to 4, the predetermined sensor 13 is fixed to the fastening member 10 by the sensor housing 14.

In FIG. 3, the predetermined sensor 13 is a cell monitor.

In FIG. 4, the predetermined sensor 13 is a temperature sensor.

In the present disclosure, it is not necessary to perform processing for fixing the predetermined sensor 13 to the single cell 12 simply by fixing the predetermined sensor 13 to the sensor housing 14.

The fuel cell stack is a stacked body in which a plurality of unit cells of the fuel cell are stacked. That is, the fuel cell stack may be a stack of a plurality of unit cells.

In the present disclosure, both the single cell and the fuel cell stack may be referred to as a fuel cell.

The number of stacked single cells is not particularly limited, and may be, for example, 2 to several hundred.

The single cell includes at least a membrane electrode gas diffusion layer assembly.

The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes a cathode catalyst layer and a cathode-side gas diffusion layer.

The anode (fuel electrode) includes an anode catalyst layer and an anode-side gas diffusion layer.

The cathode catalyst layer and the anode catalyst layer are collectively referred to as a catalyst layer. Examples of the anode catalyst and the cathode catalyst include Pt (platinum), Ru (ruthenium), and the like, and examples of the support on which the catalyst is supported include carbon materials such as carbon.

The cathode-side gas diffusion layer and the anode-side gas diffusion layer are collectively referred to as a gas diffusion layer.

The gas diffusion layer may be a conductive member or the like having gas permeability.

Examples of the conductive member include a carbon porous body such as carbon cloth and carbon paper, and a metal porous body such as a metal mesh and a metal foam.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The single cell may include two separators that sandwich both surfaces of the membrane electrode gas diffusion layer assembly as needed. The two separators are one anode-side separator and the other cathode-side separator. In the present disclosure, the anode-side separator and the cathode-side separator are collectively referred to as a separator.

The separator may have holes constituting a manifold such as a supply hole and a discharge hole for allowing a fluid such as a reaction gas and a cooling medium to flow in the stacking direction of the single cells.

As the cooling medium, for example, a mixed solution of ethylene glycol and water can be used in order to prevent freezing at low temperatures. As the cooling medium, air for cooling can be used.

Examples of the supply hole include a fuel supply hole, an oxidant gas supply hole, and a cooling medium supply hole.

Examples of the discharge hole include a fuel discharge hole, an oxidant gas discharge hole, and a cooling medium discharge hole.

The separator may have a reaction gas flow path on a surface in contact with the gas diffusion layer. In addition, the separator may have a cooling medium flow path for keeping the temperature of the fuel cell constant on a surface opposite to the surface in contact with the gas diffusion layer.

The separator may be a gas impermeable conductive member or the like. The conductive member may be, for example, dense carbon obtained by compressing carbon to make it gas-impermeable, or a press-formed metal (for example, iron, aluminum, stainless steel, or the like) plate. In addition, the separator may have a current collecting function.

In the present disclosure, the fuel gas and the oxidizing gas are collectively referred to as a reaction gas. The reaction gas supplied to the anode is a fuel gas, and the reaction gas supplied to the cathode is an oxidant gas. The fuel gas is a gas mainly containing hydrogen, and may be hydrogen. The oxidizing gas is a gas containing oxygen, and may be air or the like.

The fuel cell stack may include a manifold such as an inlet manifold in which the supply holes are in communication with each other and an outlet manifold in which the discharge holes are in communication.

Inlet manifolds include fuel inlet manifolds, oxidant inlet manifolds, and coolant inlet manifolds.

Outlet manifolds include fuel outlet manifolds, oxidant outlet manifolds, and coolant outlet manifolds.

The fuel cell stack may be configured such that both ends thereof are sandwiched between a pair of end plates. As the end plate, for example, a metal such as stainless steel can be used. As the end plate, for example, an engineering plastic containing a thermosetting resin such as phenolic resin, epoxy glass, and polyester glass can be used.

The end plate may have a plurality of through holes at predetermined positions in a region not opposed to the single cell in plan view. The region which does not face the single cell of the end plate in plan view may be a region on the surface of the end plate and outside the surface direction of the region where the single cells are stacked.

The end plate may have at least two through holes, may have three or more through holes, may have four or more through holes, may have six or more through holes, or may have twenty or less through holes.

The fuel cell stack includes a fastening member and a predetermined sensor.

The fastening member is a rod-shaped.

The fastening member is arranged along the stacking direction of the single cells.

The fastening member may be a shaft, a belt, or the like.

The shaft may be a stud bolt (both-end screw bolt) or the like.

A nut may be attached to the shaft.

A fastening load is applied to the fuel cell stack by the fastening member.

A fastening load may be applied to the fuel cell stack in the stacking direction of the single cells via a pair of end plates.

The method of applying the fastening load may be, for example, a method using a fastening machine. When the fastening member is a stud bolt and a nut, fastening by nut fastening may be performed.

The predetermined sensor is attached to the fastening member.

The predetermined sensor monitors the state of the single cell in a state of being attached to the fastening member.

The predetermined sensor may be a cell monitor, a temperature sensor, or the like.

The predetermined sensor may be fixed to the fastening member by a sensor housing.

The predetermined sensor may be fixed to the fastening member by being wound around the fastening member.

### REFERENCE SIGNS LIST

10 Fastening member
11 End plate
12 Single cell
13 Predetermined sensor
14 Sensor housing
100 Fuel cell stack

1. A fuel cell stack,
wherein the fuel cell stack is a stack of a plurality of single cells;
wherein the fuel cell stack comprises a fastening member and a predetermined sensor;
wherein the fastening member is rod-shaped;
wherein the fastening member is arranged along a stacking direction of the single cells;
wherein the predetermined sensor is attached to the fastening member; and
wherein the predetermined sensor is configured to monitor a condition of the single cells in a state of being attached to the fastening member.

2. The fuel cell stack according to claim 1,
wherein the predetermined sensor is at least one of a cell monitor and a temperature sensor.
